(19) United States
(12) Patent Application Publication
(10) Pub. No.: US 2011/0148716 A1
(43) Pub. Date: Jun. 23, 2011

(54) MULTIPLE RESONANCE ANTENNA, MANUFACTURING METHOD THEREFOR AND COMMUNICATION DEVICE

(75) Inventors: Naoki SOTOMA, Tokyo (JP); Hideaki Shimoda, Tokyo (JP); Junichiro Urabe, Tokyo (JP); Noriyuki Hirabayashi, Tokyo (JP)

(73) Assignee: TDK CORPORATION, Tokyo (JP)

(21) Appl. No.: 12/967,706

(22) Filed: Dec. 14, 2010

(30) Foreign Application Priority Data
Dec. 18, 2009 (JP) 2009-287495

(51) Int. Cl. H01Q 1/38; H01P 11/00

(52) U.S. Cl. 343/700 MS; 29/600

(57) ABSTRACT

A multiple resonance antenna includes a dielectric substrate, a first antenna electrode and a second antenna electrode, the first and second antenna electrodes being disposed together on the dielectric substrate with first ends connected to each other but with second ends remaining free, the dielectric substrate including a high-dielectric part having a higher relative permittivity than another part, the high-dielectric part being disposed beneath a part of the first antenna electrode including the second end.

### BACKGROUND OF THE INVENTION

1. Field of the Invention

The present invention relates to a multiple resonance antenna, a manufacturing method therefor, and a communication device using the same.

2. Description of the Related Art

A multiple resonance antenna includes two antenna electrodes of different resonance frequencies per one element and therefore can deal with different two frequency bands even though it is a single element. Typically, the antenna electrodes are each formed as a λ/4 monopole antenna and branch off from a common power feeding path. Examples of devices to which the multiple resonance antenna is applicable include a mobile communication device having both functions of GPS (global positioning system) and Bluetooth (which is a registered trademark, though not mentioned again), such as a mobile phone. GPS utilizes radio waves of 1.57 GHz band, while Bluetooth utilizes radio waves of 2.45 GHz band, so that the multiple resonance antenna has to be able to deal with these frequency bands.

Such a multiple resonance antenna for the mobile communication device can be constructed to have a low-frequency antenna electrode and a high-frequency antenna electrode disposed together on a rectangular parallelepiped dielectric substrate. Since the mobile communication devices into which it is to be incorporated are required to be much smaller and have more functionality and higher packaging density, further miniaturization is required for the multiple resonance antenna of this type.

Miniaturization may be achieved by bending back the low-frequency antenna electrode at a few points. However, although this solution can ensure an effective electrical length for the low-frequency antenna electrode, radiation characteristics may be deteriorated by the bend.

On the other hand, the dielectric substrate may be made of a material having a high relative permittivity so as to ensure the electrical length without having too many bends. With this structure, however, there is a problem of deteriorating radiation characteristics of the high-frequency antenna electrode. This is because the physical length of the high-frequency antenna electrode is extremely shortened, narrowing the effective bandwidth.

In this case, therefore, antenna characteristics of the high-frequency antenna electrode are deteriorated as compared with those of the low-frequency antenna electrode, causing an imbalance of antenna characteristics between the low-frequency one and the high-frequency one.

To overcome this problem, it is possible to dispose the low-frequency antenna electrode and the high-frequency antenna electrode on different dielectric layers having different relative permittivities, as in a multiple resonance antenna disclosed in Japanese Patent No. 3663989, for example.

Even with this structure, however, since the high-frequency antenna electrode is covered with the dielectric substrate for the low-frequency antenna electrode, it is also impossible to avoid deterioration of radiation characteristics of the high-frequency antenna electrode.

In addition, disposing the two antenna electrodes on different dielectric layers results in increasing the overall thickness to prevent miniaturization and also requiring a through-hole between the layers to reduce the yield and increase the cost.

### SUMMARY OF THE INVENTION

An object of the present invention is to provide a low-cost multiple resonance antenna which can keep a balance between high-frequency antenna characteristics and low-frequency antenna characteristics while achieving miniaturization, a manufacturing method therefor, and a communication device using the same.

In order to achieve the above object, a multiple resonance antenna according to the present invention comprises a dielectric substrate, a first antenna electrode and a second antenna electrode.

The first and second antenna electrodes are disposed together on the dielectric substrate with first ends connected to each other but with second ends remaining free.

Since the multiple resonance antenna according to the present invention has a structure that the first and second antenna electrodes whose one ends are connected to each other are disposed together on the dielectric substrate, as described above, miniaturization and cost reduction can be effectively achieved as compared with the above multilayered one.

Then, the characteristic feature of the present invention resides in that the dielectric substrate includes a high-dielectric part having a higher relative permittivity than another part and the high-dielectric part is disposed beneath a part of the first antenna electrode including the second end.

In the multiple resonance antenna according to the present invention, when the first antenna electrode is used as the low-frequency antenna electrode and the second antenna electrode is used as the high-frequency antenna electrode, the high-dielectric part having a high permittivity is disposed beneath a part of the first antenna electrode including a free end and having a maximum magnetic field strength. Hence, the first antenna electrode can ensure a necessary electrical length with having few bends.

In addition, since the high-dielectric part is disposed beneath said part of the first antenna electrode, it hardly affects radiation characteristics of the second antenna electrode. Thus, the second antenna electrode can ensure an effective bandwidth.

Therefore, the multiple resonance antenna according to the present invention can achieve a balance between the high-frequency antenna characteristics and the low-frequency antenna characteristics.

Moreover, in a method for manufacturing the multiple resonance antenna according to the present invention, the dielectric substrate is formed such that a part other than the high-dielectric part is formed in advance, and the high-dielectric part is subsequently formed by outsert molding. Alternatively, the method may be such that the high-dielectric part is formed in advance, and a part other than the high-dielectric part is subsequently formed by insert molding.

In the method for manufacturing the multiple resonance antenna according to the present invention, outsert molding or insert molding is used for formation of the dielectric substrate, so that the dimensional deviation can be reduced as compared with the case where individual parts are separately formed and then joined together, making it possible to properly reduce unevenness such as a difference in level that may be created at a border between the high-dielectric part and the other part. This effectively prevents the reduction of the yield of the product and therefore reduces the cost.

Furthermore, a communication device according to the present invention comprises the above multiple resonance antenna, a low-frequency communication unit and a high-frequency communication unit. The multiple resonance antenna is connected to the low-frequency and high-frequency communication units.

Since the communication device according to the present invention includes the above multiple resonance antenna, it has the same effects as described above.

The other objects, constructions and advantages of the present invention will be further detailed below with reference to the attached drawings. However, the attached drawings show only illustrative examples.

### BRIEF DESCRIPTION OF THE DRAWINGS

FIG. 1 is a perspective view showing one embodiment of a multiple resonance antenna according to the present invention;

FIG. 2 is a sectional view taken along line II-II in FIG. 1;

FIG. 3 is a sectional view taken along line III-III in FIG. 1;

FIG. 4 is a sectional view of a FPC which can be used for a multiple resonance antenna according to the present invention;

FIG. 5 is simulation data showing frequency-efficiency characteristics of a low-frequency antenna electrode of a multiple resonance antenna according to the present invention in comparison with those of comparative examples;

FIG. 6 is simulation data showing frequency-efficiency characteristics of a high-frequency antenna electrode of a multiple resonance antenna according to the present invention in comparison with those of comparative examples;

FIG. 7 is a perspective view of a multiple resonance antenna of a comparative example 1 shown in FIGS. 5 and 6; and

FIG. 8 is a block diagram of a communication device according to the present invention.

### DESCRIPTION OF THE PREFERRED EMBODIMENTS

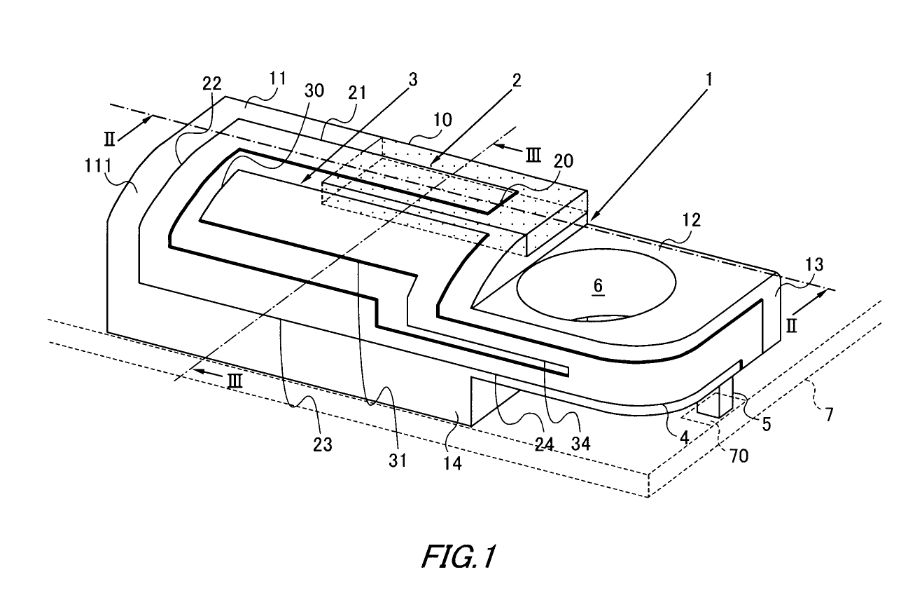

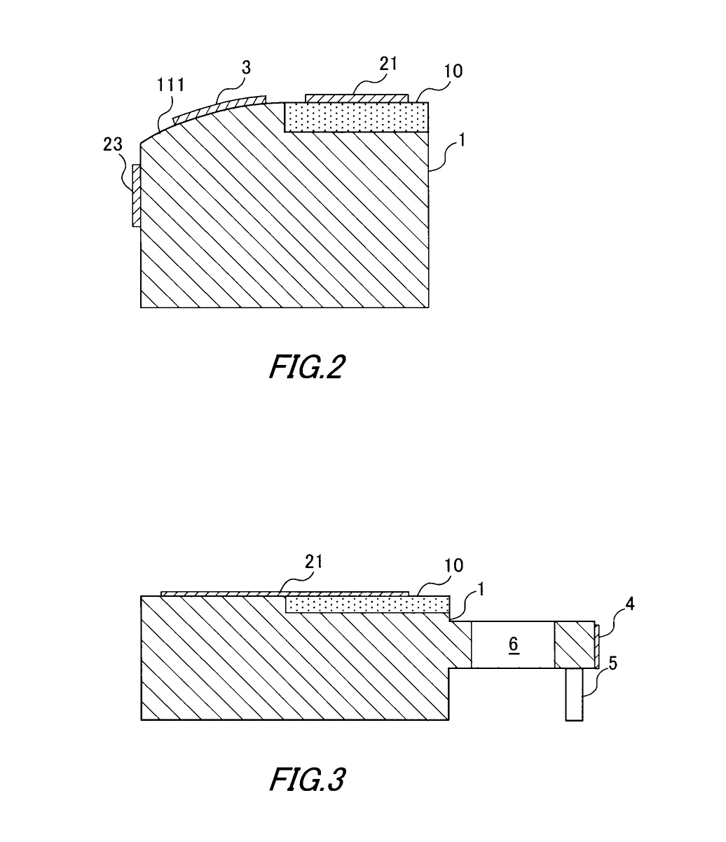

Referring to FIGS. 1 to 3, a multiple resonance antenna according to the present invention includes a dielectric substrate 1, a first antenna electrode 2 and a second antenna electrode 3 disposed together on the dielectric substrate 1, a power feeding electrode 4, and a connection electrode 5. It should be noted that the multiple resonance antenna in the figure is illustrated as being mounted on a circuit board 7 represented by dotted lines, for convenience.

The dielectric substrate 1 is preferably made of a composite dielectric material being a mixture of a synthetic resin and dielectric ceramic powder. For example, the synthetic resin may be ABS (acrylonitrile butadiene styrene) resin or PC (polycarbonate) resin. The dielectric ceramic powder may be barium titanate series ceramic powder or titanium oxide series ceramic powder. Advantageously, the use of such a composite dielectric material makes it possible to adjust the relative permittivity of the dielectric substrate 1, form the dielectric substrate 1 into a required shape by using a molding technique, and color the dielectric substrate 1 by mixing a pigment.

The dielectric substrate 1 may take any shape depending on products to which the multiple resonance antenna is to be applied, but in the present embodiment, it is formed as a convex member having two top faces 11, 12 at different height positions and peripheral walls 13, 14. The height position of a bottom face that is opposite to the top face 12 at a lower height position is higher than the height position of a bottom face that is opposite to the other top face 11, and at this bottom face, the connection electrode 5 is provided in the form of a square pole having a height corresponding to the difference. This connection electrode 5 is electrically connected to a board-side electrode 70 formed on the circuit board 7.

Moreover, the top face 12 has an opening of a through-hole 6 extending in a cylindrical shape toward the bottom face. The through-hole 6 can be used not only for positioning or securing upon mounting the multiple resonance antenna on the circuit board 7 or the like but also for reducing the amount of a dielectric material to be used. The shape of the through-hole 6 is not limited to the present embodiment but may vary with embodiments.

At an area of the top face 11 close to the peripheral wall 14, furthermore, there is formed a slope 111 to have a parabolic corner, facilitating the formation of the following antenna electrodes 2, 3 as compared with the case where the corner is angular.

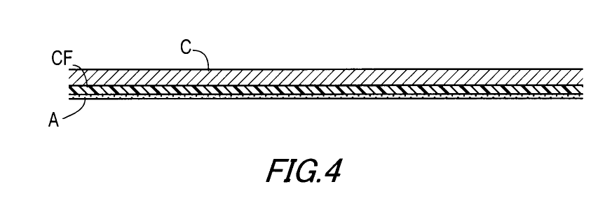

Preferably, the first antenna electrode 2 and the second antenna electrode 3 are formed by a FPC (flexible printed circuits), as shown in FIG. 4. Specifically, the first antenna electrode 2 and the second antenna electrode 3 are supported by a flexible insulating film CF with an adhesive layer A, wherein the flexible insulating film CF is adhered onto the dielectric substrate 1 by utilizing adhesion of the adhesive layer A. On the flexible insulating film CF, there is disposed an electrode film C having a pattern of the antenna electrodes 2, 3.

With this structure, the first antenna electrode 2 and the second antenna electrode 3 can easily be formed by adhering the FPC to the dielectric substrate 1, increasing the production efficiency and reducing the cost. Moreover, since the dielectric substrate 1 has the slope 111, as described above, the FPC can easily be adhered to extend from the top face 11 to the peripheral wall 14 without folding.

Furthermore, since the first antenna electrode 2 and the second antenna electrode 3 can be formed by patterning the flexible insulating film CF, high patterning accuracy can be ensured for the first antenna electrode 2 and the second antenna electrode 3.

The first antenna electrode 2 and the second antenna electrode 3 are each formed as a λ/4 monopole antenna and branch off from the common power feeding electrode 4 extending from the side wall 13 to the side wall 14. That is, the first antenna electrode 2 and the second antenna electrode 3 are formed such that their first ends are connected to each other but their second ends 20, 30 remain free.

The first antenna electrode 2 is bent back to have a greater length between the first and second ends than the second antenna electrode, providing a lead part 24, a forward part 23, a bend part 22, and a backward part 22. The lead part 24 is narrower than the other parts and extends on the peripheral wall 14 from the front end of the power feeding electrode 4 to the rear end of the forward part 23.

The forward part 23 is disposed on the peripheral wall 14, while the bend part 22 and the backward part 21 are disposed on the top face 11. They are arranged in C shape to enclose the second antenna electrode 3. Thus, the second antenna electrode 3 is disposed between the forward part 23 before the bend part 22 and the backward part 21 after the bend of the first antenna electrode 2.

The second antenna electrode 3 has a main part 31 and a lead part 34.

The main part 31 is disposed on the slope 111 in a spaced parallel relationship with the forward part 23 and the backward part 21 with its front end 30 being opposed to the bend part 22. The lead part 34 is narrower than the main part 31 and extends on the peripheral wall 14 from the front end of the power feeding electrode 4 to the rear end of the main part 31.

The lengths of the first antenna electrode 2 and the second antenna electrode 3 are each determined to have an electrical length λ/4 taking into consideration its intended frequency and the relative permittivity of the dielectric substrate 1. For example, when the multiple resonance antenna according to the present invention is to be used for a mobile communication device having a function of GPS and a function of Bluetooth, such as a mobile phone, the length of the first antenna electrode 2 is set to a dimension corresponding to the radio waves of 1.57 GHz band for GPS, while the length of the second antenna electrode 3 is set to a dimension corresponding to the radio waves of 2.45 GHz band for Bluetooth.

Since the multiple resonance antenna according to the present invention has a structure that the first and second antenna electrodes 2, 3 whose one ends are connected to each other are disposed together on the dielectric substrate 1, as described above, miniaturization and cost reduction can be effectively achieved as compared with the above multilayered one.

Then, the characteristic feature of the present invention resides in that the dielectric substrate 1 includes a high-dielectric part 10 having a higher relative permittivity than the other part and the high-dielectric part 10 is disposed beneath a part of the first antenna electrode 2 including the terminal end 20.

In the present embodiment, the high-dielectric part 10 is, but not limited thereto, a rectangular parallelepiped member whose one face forms a part of the top face 11. The high-dielectric part 10 may take any shape as long as it is located at or in the vicinity of the terminal end 20 of the first antenna electrode 2, for example. Moreover, as a material suitable for forming the high-dielectric part 10, there can be used a ceramic, but other materials may also be used. Preferably, εr1: εr2=1:5 to 1:30, where εr1 represents the relative permittivity of the high-dielectric part 10 and εr2 represents the relative permittivity of the other part of the dielectric substrate 1.

In the multiple resonance antenna according to the present invention, when the first antenna electrode 2 is used as the low-frequency antenna electrode and the second antenna electrode 3 is used as the high-frequency antenna electrode, the high-dielectric part 10 having a high permittivity is disposed beneath a part of the first antenna electrode 2 including the free end and having a maximum magnetic field strength. Hence, the first antenna electrode 2 can ensure a necessary electrical length with having few bends.

In addition, since the high-dielectric part 10 is disposed beneath said part of the first antenna electrode 2, it hardly affects radiation characteristics of the second antenna electrode 3. Thus, the second antenna electrode 3 can ensure an effective bandwidth.

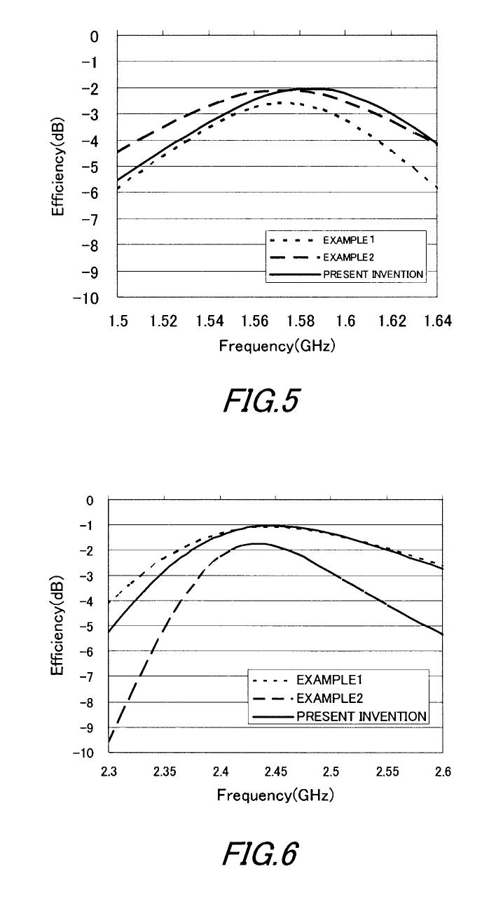

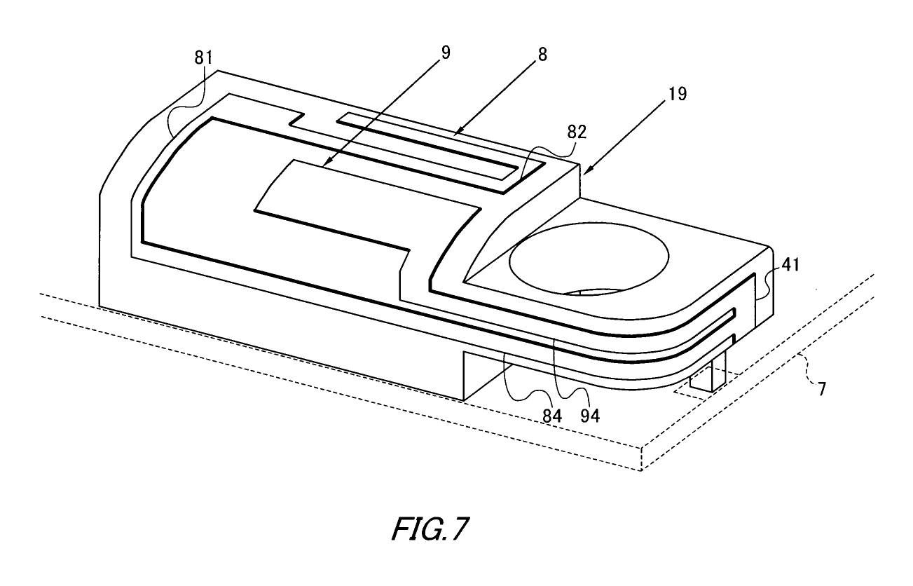

Therefore, the multiple resonance antenna according to the present invention can achieve a balance between the high-frequency antenna characteristics and the low-frequency antenna characteristics. This can be clearly understood with reference to FIGS. 5 and 6.

FIGS. 5 and 6 are simulation data showing frequency-efficiency characteristics of the multiple resonance antenna according to the present invention in comparison with those of comparative examples, for the low-frequency antenna electrode and the high-frequency antenna electrodes, respectively. Here, the high-dielectric part 10 according to the present invention is made of a dielectric ceramic to have a relative permittivity of 48. On the other hand, the part other than the high-dielectric part 10 is made of a mixture of ABS resin and PC resin to have a relative permittivity of 2.8. Here, two types of multiple resonance antennas were used for the comparative example.

At first, the comparative example 1 is a multiple resonance antenna shown in FIG. 7. This multiple resonance antenna of the comparative example 1 has a first antenna electrode 8 and a second antenna electrode 9 as in the foregoing embodiment. However, the multiple resonance antenna of the comparative example 1 is not provided with the high-dielectric part 10, but a whole dielectric substrate 19 is uniformly made of a mixture of ABS resin and PC resin to have a relative permittivity of 2.8. In order to ensure the electrical length, therefore, lead parts 84, 94 of the first antenna electrode 8 and the second antenna electrode 9 are made longer than those of the foregoing embodiment. Furthermore, the first antenna electrode 8 has increased two bend parts 81, 82.

In a multiple resonance antenna of the comparative example 2, on the other hand, although not illustrated, a whole dielectric substrate is uniformly made of a mixture of ABS resin, PC resin, and titanium dioxide to have a high relative permittivity, i.e., εr=6, whereby the first antenna electrode and the second antenna electrode are formed in the same shape as in the foregoing embodiment according to the present invention.

In FIGS. 5 and 6, the frequency (GHz) is plotted in abscissa and the efficiency (dB) is plotted in ordinate. Specifically, FIG. 5 shows a GPS band obtained from the first antenna electrode 2, i.e., the efficiency of the low-frequency antenna electrode. On the other hand, FIG. 6 shows a Bluetooth band obtained from the second antenna electrode 3, i.e., the efficiency of the high-frequency antenna electrode. It should be noted that the efficiency specifically refers to radiation efficiency and is an index of antenna's reception efficiency.

Regarding FIG. 5, i.e., the low-frequency antenna electrode, at first, since the comparative example 1 has radiation characteristics deteriorated by the increased two bend parts 81, 82, its efficiency is lower than those of the other two. Regarding FIG. 6, i.e., the high-frequency antenna electrode, on the other hand, since the comparative example 2 has a narrow bandwidth due to a high relative permittivity of the whole dielectric substrate, its efficiency is lower than those of the other two.

These results merely confirm what has been described above, but it is notable that the multiple resonance antenna according to the present invention has well-balanced excellent efficiency for both the low-frequency antenna electrode and the high-frequency antenna electrode (See solid lines in FIGS. 5 and 6). This confirms that the multiple resonance antenna according to the present invention is capable of providing high-quality radio communication.

Since excellent antenna characteristics can be obtained only by providing the high-dielectric part 10 as a part of the dielectric substrate 1, as described above, cost advantage can be further achieved by a multiple resonance antenna manufacturing method that will be described below.

In a method for manufacturing the multiple resonance antenna according to the present invention, the dielectric substrate 1 is formed such that a part other than the high-dielectric part 10 is formed in advance, and the high-dielectric part 10 is subsequently formed by outsert molding. Alternatively, the method may be such that the high-dielectric part 10 is formed in advance, and a part other than the high-dielectric part 10 is subsequently formed by insert molding. More specifically, the manufacturing method is such that after the high-dielectric part 10 or the other part is formed in advance and put in a die, the rest is formed by injection molding.

In the method for manufacturing the multiple resonance antenna according to the present invention, outsert molding or insert molding is used for formation of the dielectric substrate, so that the dimensional deviation can be reduced as compared with the case where individual parts are separately formed and then joined together, making it possible to properly reduce unevenness such as a difference in level that may be created at a border between the high-dielectric part 10 and the other part. This effectively prevents the reduction of the yield of the product and therefore reduces the cost. Here, the selection regarding which part of the dielectric substrate 1 to be formed in advance should be made depending on properties of individual materials used.

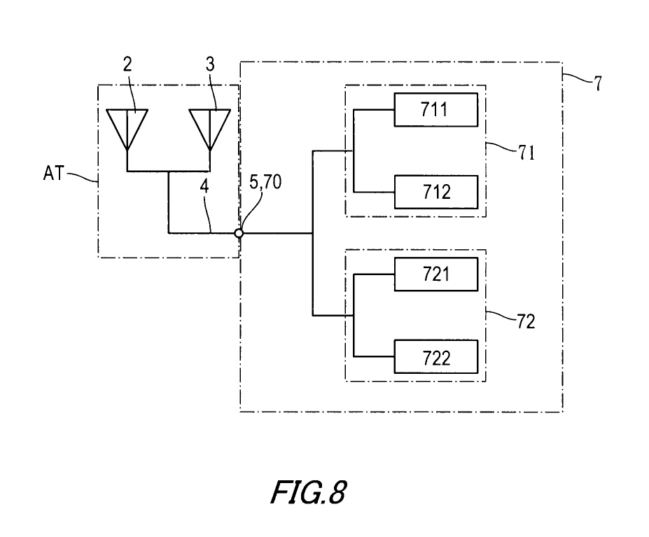

Preferably, the multiple resonance antenna thus far described is applied to a communication device. FIG. 8 shows one embodiment. The illustrated communication device includes a multiple resonance antenna AT according to the present invention and a low-frequency communication unit 71 and a high-frequency communication unit 72 disposed on the above circuit board 7. Although not shown in the figure, of course, there are also provided circuit elements necessary for a communication device of this type.

The multiple resonance antenna AT includes the first antenna electrode 2 and the second antenna electrode 3, and their details are the same as described above. The power feeding path 4 of the multiple resonance antenna AT is connected to the board-side electrode 70 via the connection electrode 5 and further to an input-output side of the low-frequency communication unit 71 and the high-frequency communication unit 72. For example, the low-frequency communication unit 71 has a function of GPS, while the high-frequency communication unit 72 has a function of Bluetooth. The low-frequency communication unit 71 has a transmitting circuit 711 and a receiving circuit 712, and the high-frequency communication unit 72 has a transmitting circuit 721 and a receiving circuit 722.

Since the communication device according to the present invention includes the above multiple resonance antenna, it has the same effects as described above. According to the communication device of the present invention, therefore, well-balanced excellent reception efficiency can be obtained based on antenna characteristics as shown in FIGS. 5 and 6.

The present invention has been described in detail above with reference to preferred embodiments. However, obviously those skilled in the art could easily devise various modifications of the invention based on the technical concepts underlying the invention and teachings disclosed herein.

What is claimed is:

1. A multiple resonance antenna comprising a dielectric substrate, a first antenna electrode and a second antenna electrode,
the first and second antenna electrodes being disposed together on the dielectric substrate with first ends connected to each other but with second ends remaining free,
the dielectric substrate including a high-dielectric part having a higher relative permittivity than another part,
the high-dielectric part being disposed beneath a part of the first antenna electrode including the second end.

2. The multiple resonance antenna of claim 1, wherein the first antenna electrode is bent back to have a greater length between the first and second ends than the second antenna electrode, and
the second antenna electrode is disposed between a forward part before the bend and a backward part after the bend of the first antenna electrode.

3. The multiple resonance antenna of claim 1, wherein the first and second antenna electrodes are supported by an adhesive, flexible insulating film, and the flexible insulating film is adhered onto the dielectric substrate.

4. A method for manufacturing the multiple resonance antenna of claim 1, wherein the dielectric substrate is formed such that a part other than the high-dielectric part is formed in advance, and the high-dielectric part is subsequently formed by outsert molding.

5. A method for manufacturing the multiple resonance antenna of claim 1, wherein the dielectric substrate is formed such that the high-dielectric part is formed in advance, and a part other than the high-dielectric part is subsequently formed by insert molding.

6. A communication device comprising the multiple resonance antenna of claim 1, a low-frequency communication unit and a high-frequency communication unit, the multiple resonance antenna being connected to the low-frequency and high-frequency communication units.
